(19) United States
(12) Patent Application Publication
(10) Pub. No.: US 2005/0134580 A1
(43) Pub. Date: Jun. 23, 2005

(54) Display device

(75) Inventors: Shinichiro Sonoda, Kanagawa-ken (JP); Takamichi Fujii, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/952,850

(22) Filed: Sep. 30, 2004

(30) Foreign Application Priority Data
Sep. 30, 2003 (JP) (PAT.)340562/2003

(51) Int. Cl. B32B 3/26; G09G 5/00; B41M 5/00

(52) U.S. Cl. 345/211; 428/304.4; 428/474.4

(57) ABSTRACT

A display device is made up of a transparent porous layer, a colored layer, and a penetrant-moving part. The transparent porous layer is formed from a transparent material and has pores into which a penetrant is penetrable. The colored layer is stacked on one surface of the transparent porous layer. The penetrant-moving part is used for performing penetration of the penetrant into the transparent porous layer or discharge of the penetrant from the transparent porous layer. After the penetration of the penetrant into the transparent porous layer performed by the penetrant-moving part, the transparent porous layer becomes transparent and therefore the colored layer is displayed through the transparent porous layer. After the discharge of the penetrant from the transparent porous layer performed by the penetrant-moving part, the transparent porous layer becomes opaque and therefore the transparent porous layer is displayed.

### BACKGROUND OF THE INVENTION

1. Field of the Invention

The present invention relates to a display device, and more particularly to a display device making use of the movement of a penetrant under the influence of an electric field.

2. Description of the Related Art

There is known a display device that performs display by changing the reflection, refraction, and scattering of light incident on a porous body, utilizing the movement of a penetrant into the porous body across which a difference of potential is applied. For example, as shown in FIGS. 11A and 11B, such a display device is made up of a transparent porous panel 82 with a great number of grooves 81 formed in the screen; top electrodes 83a (which are also used as light-intercepting plates) disposed on the top surface of the porous panel 82; and transparent bottom electrodes 83b disposed on the bottom surface of the porous panel 82 (see Japanese Unexamined Patent Publication No. 56(1981)-88177). This display device forms an electric field in the direction of the thickness of the porous panel 82 by applying a potential difference between the top and bottom electrodes. This causes the display device to change the reflection, refraction, and scattering of light Lₑ incident on the side of the top electrodes 83a or on the side of the bottom electrodes 83b, by switching between a supply state in which a penetrant L5 is moved toward the top electrodes 83a and penetrates into the spaces 84 surrounded by the grooves 81 (see FIG. 11A), and a discharge state in which the penetrant L5 is discharged from the spaces 84 and moved toward the bottom electrodes 83b (see FIG. 11B). In this manner, display is performed.

However, because there is no possibility that light incident on the surface, on which the top electrodes 83 are disposed and in which the grooves 81 are not formed, will be utilized for display, it is difficult for the above-described display device to have sufficient contrast. In addition, in the display device, no electric field is formed in the spaces 84 where the porous body of the porous panel 82 is not present, so the control of the penetrant L5 in the grooved surface portions is reduced. Because of this, there are cases where the spaces 84 are not sufficiently filled with the penetrant L5, or discharge of the penetrant L5 from the spaces 84 is not sufficient. As a result, the reflection, refraction, and scattering of light Lₑ incident on the spaces 84 are reduced, and contrast is decreased.

### SUMMARY OF THE INVENTION

The present invention has been developed in view of the circumstances described above. Accordingly, it is the primary object of the present invention to provide a display device that is capable of enhancing contrast.

To achieve this end, there is provided a display device comprising (1) a transparent porous layer, formed from a transparent material, which has pores into which a penetrant is penetrable; (2) a colored layer stacked on one surface of the transparent porous layer; and (3) penetrant-moving means for performing penetration of the penetrant into the transparent porous layer or discharge of the penetrant from the transparent porous layer. After the penetration of the penetrant into the transparent porous layer is performed by the penetrant-moving means, the transparent porous layer becomes transparent and therefore the colored layer is displayed through the transparent porous layer. After the discharge of the penetrant from the transparent porous layer performed by the penetrant-moving means, the transparent porous layer becomes opaque and therefore the transparent porous layer is displayed.

In the display device according to the present invention, the aforementioned colored layer may be a colored porous layer with pores into which the penetrant is penetrable. When the penetrant penetrates into the transparent porous layer, the colored porous layer supplies the penetrant from the colored porous layer to the transparent porous layer. When the penetrant is discharged from the transparent porous layer, the colored porous layer absorbs the discharged penetrant.

In the display device according to the present invention, the aforementioned penetrant-moving means may be made up of electrodes, which are respectively disposed on the top and bottom surfaces of a stacked structure comprising the transparent porous layer and colored porous layer; and a potential difference application part for applying a potential difference between the electrodes disposed on the top and bottom surfaces of the stacked structure. The aforementioned penetrant-moving means may also be made up of electrodes, which are respectively disposed on the top and bottom surfaces of the colored porous layer; and a potential difference application part for applying a potential difference between the electrodes disposed on the top and bottom surfaces of the colored porous layer. Furthermore, the aforementioned penetrant-moving means may be made up of electrodes, which are respectively disposed on the top and bottom surfaces of the transparent porous layer; and a potential difference application part for applying a potential difference between the electrodes disposed on the top and bottom surfaces of the transparent porous layer.

In the display device according to the present invention, capillary attraction, which is produced in the colored porous layer when the penetrant penetrates into the colored porous layer, may be made greater than that of the transparent porous layer.

The display device of the present invention may further include a transparent penetrant storage layer, interposed between the transparent porous layer and the colored layer, for storing the penetrant. When the penetrant penetrates into the transparent porous layer, the penetrant storage layer supplies the penetrant from the penetrant storage layer to the transparent porous layer. When the penetrant is discharged from the transparent porous layer, the penetrant storage layer stores the discharged penetrant. Moreover, the aforementioned penetrant-moving means may be made up of eletrodes, which are respectively disposed on the top and bottom surfaces of the transparent porous layer; and a potential difference application part for applying a potential difference between the electrodes disposed on the top and bottom surfaces of the transparent porous layer.

The aforementioned penetrant storage layer may be of any type, so long as it is in the form of a layer capable of storing a penetrant. It may also be in the form of a container to store a penetrant. Moreover, it may be formed from a foaming resin material.

In the display device according to the present invention, a pore diameter in the transparent porous layer can be made greater the further it is away from the colored layer in the direction of the thickness of the two layers. Note that if the pore diameter becomes greater the further it is away from the colored layer in the thickness direction, it means that capillary attraction becomes smaller the further it is away from the colored layer in the thickness direction.

It is preferable that a pore diameter in the transparent porous layer be between 0.1 μm and 10 μm. When the colored layer is the colored porous layer, it is preferable that a pore diameter in the colored porous layer be between 0.1 μm and 10 μm. Note that the expression “a pore diameter is between 0.1 μm and 10 μm” as used herein is not limited to the case where the pore diameter of all pores in the transparent porous layer and colored porous layer is between 0.1 μm and 10 μm. However, it is necessary that the pore diameter of 90% or more of all pores in the transparent porous layer and colored porous layer be between 0.1 μm and 10 μm.

In the display device according to the present invention, the aforementioned colored layer may be colored black.

The aforementioned penetrant-moving means may exert the Coulomb forces of different magnitudes on the penetrant in the thickness direction at different positions on a plane perpendicular to the thickness direction. Also, the aforementioned colored layer may be colored in different hues at different positions on a plane perpendicular to the thickness direction. The different hues maybe yellow, magenta, cyan, and black.

In the display device of the present invention, a main material constituting the aforementioned transparent porous layer may be cellulose nitrate, acetyl cellulose, cellulose acetate, vinyl chloride, polypropylene, polyamide, polytetrafluorethylene, polyolefin, polysulfone, glass fiber, or alumina. Also, a main material constituting the colored porous layer may be cellulose nitrate, acetyl cellulose, cellulose acetate, vinyl chloride, polypropylene, polyamide, polytetrafluorethylene, polyolefin, polysulfone, glass fiber, or alumina.

The aforementioned transparent porous layer may be formed from a mixture of any two or more of resin, ceramic, and glass materials. Also, the aforementioned colored porous layer may be formed from a mixture of any two or more of resin, ceramic, and glass materials.

The expression “the colored layer is displayed” as used herein is intended to mean that the colored layer is visible to the naked eye through the transparent porous layer.

The aforementioned colored layer is not limited to the case where it is colored in various hues. That is, it may be colored black or gray. Furthermore, the colored layer is not limited to the case where it is formed by being colored. For instance, a material that constitutes the colored layer may assume the aforementioned color.

The aforementioned transparent porous layer is not always colorless and transparent, but may assume any color if it is transparent.

Note that the electrodes disposed on the transparent porous layer are constructed so that when the transparent porous layer is made transparent and the colored layer is displayed, the colored layer is visible to the naked eye through the transparent porous layer. For instance, these electrodes may be electrodes arranged in the form of a mesh, or transparent electrodes.

Also, the electrodes between the aforementioned transparent porous layer and colored porous layer, or between the transparent porous layer and penetrant storage layer are disposed so the penetrant can pass through them.

As set forth above, the display device of the present invention comprises the transparent porous layer, formed from a transparent material, which has pores into which a penetrant is penetrable; the colored layer stacked on one surface of the transparent porous layer; and the penetrant-moving means for performing penetration of the penetrant into the transparent porous layer or discharge of the penetrant from the transparent porous layer. After the penetration of the penetrant into the transparent porous layer performed by the penetrant-moving means, the transparent porous layer becomes transparent and the colored layer is displayed through the transparent porous layer. And after the discharge of the penetrant from the transparent porous layer performed by the penetrant-moving means, the transparent porous layer becomes opaque and the transparent porous layer is displayed. Therefore, by making the entire surface of the transparent porous layer opaque or transparent, the colored layer can be displayed. Thus, the rate of an area where the reflection, refraction, and scattering of light occur can be increased compared to the prior art, so contrast can be enhanced. In addition, the Coulomb force can be exerted on a penetrant in the entire surface of the aforementioned transparent porous layer, so control in moving the penetrant can also be enhanced.

According to the present invention, the colored layer is a colored porous layer with pores into which the penetrant is penetrable. When the penetrant penetrates into the transparent porous layer, the colored porous layer supplies the penetrant from the colored porous layer to the transparent porous layer. When the penetrant is discharged from the transparent porous layer, the colored porous layer absorbs the discharged penetrant. Therefore, the supply and discharge of the penetrant with respect to the transparent porous layer can be easily performed.

According to the present invention, the penetrant-moving means is made up of electrodes, which are respectively disposed on the top and bottom surfaces of a stacked structure comprising the transparent porous layer and colored porous layer; and a potential difference application part for applying a potential difference between the electrodes disposed on the top and bottom surfaces of the stacked structure. Or, the penetrant-moving means is made up of electrodes, which are respectively disposed on the top and bottom surfaces of the colored porous layer; and a potential difference application part for applying a potential difference between the electrodes disposed on the top and bottom surfaces of the colored porous layer. Therefore, the Coulomb force can be reliably exerted on the penetrant.

If the capillary attraction, which is produced in the colored porous layer when the penetrant penetrates into the colored porous layer, is greater than that of the transparent porous layer, the penetrant is discharged from the transparent porous layer when no Coulomb force is exerted on the penetrant by the penetrant-moving means. This state, in which the transparent porous layer becomes opaque after the movement of the penetrant into the colored porous layer, can be employed as a default state.

According to the present invention, the display device is further equipped with a transparent penetrant storage layer, interposed between the transparent porous layer and the colored layer, for storing the penetrant. When the penetrant penetrates into the transparent porous layer, the penetrant storage layer supplies the penetrant from the penetrant storage layer to the transparent porous layer. When the penetrant is discharged from the transparent porous layer, the penetrant storage layer stores the discharged penetrant. Therefore, the supply and discharge of the penetrant with respect to the transparent porous layer can be readily performed. In addition, according to the present invention, the penetrant-moving means is made up of electrodes, which are respectively disposed on the top and bottom surfaces of the transparent porous layer; and a potential difference application part for applying a potential difference between the electrodes disposed on the top and bottom surfaces of the transparent porous layer. This makes it possible to exert the Coulomb force on the penetrant more reliably.

According to the present invention, a pore diameter in the transparent porous layer is made greater the further it is away from the colored layer in the direction of the thickness of the two layers. For example, when the transparent porous layer is displayed by discharging the penetrant from the transparent porous layer, and when the colored porous layer is displayed by penetration of the penetrant into the transparent porous layer, a change in display can be made appropriate. Therefore, when a specified brightness is shifted to a brightness different from that brightness, the afterimage of the display can be optimized. Also, when the colored layer is a colored porous layer with pores into which a penetrant is penetrable, a region of the transparent porous layer in contact with the colored layer plays a role of preventing the moving time of the penetrant from being too short when the penetrant in the colored layer penetrates into the transparent porous layer during application of the Coulomb force, if a pore diameter in that contact region is made smallest and the thickness of a region whose pore diameter is smaller than that of the colored layer is made sufficiently thinner than that of the colored layer. In addition, when no Coulomb force is exerted, the penetrant in the transparent porous layer plays a role of resistance in penetrating into the colored layer and can prolong the moving time of the penetrant. Thus, display is able to have an afterimage (memory effect).

According to the present invention, a pore diameter in the transparent porous layer is between 0.1 μm and 10 μm. When the colored layer is the colored porous layer, a pore diameter in the colored porous layer is between 0.1 μm and 10 μm. Therefore, penetration and discharge of the penetrant with respect to the transparent porous layer and colored porous layer can be more easily performed.

According to the present invention, the penetrant-moving means is able to exert the Coulomb forces of different magnitudes on the penetrant in the thickness direction at different positions on a plane perpendicular to the thickness direction. This makes it possible to change brightness at different positions. For example, images can be displayed. In addition, the colored layer can be colored in different hues at different positions on a plane perpendicular to the thickness direction. This renders it possible to display color images.

### BRIEF DESCRIPTION OF THE DRAWINGS

The present invention will be described in further detail with reference to the accompanying drawings wherein:

FIG. 1 is a perspective view showing a display device constructed in accordance with a first embodiment of the present invention;

FIG. 2 is an exploded perspective view showing a construction for exerting the Coulomb force on a penetrant;

FIG. 3A is a perspective view showing another construction for exerting the Coulomb force on the penetrant;

FIG. 3B is a perspective view showing the construction of FIG. 3A in further detail;

FIG. 3C is a diagram showing a circuit for exerting the Coulomb force on the penetrant;

FIG. 4A is a perspective view showing the state in which white is displayed by the display device shown in FIG. 1;

FIG. 4B is a perspective view showing the state in which black is displayed by the display device shown in FIG. 1;

FIG. 4C is a perspective view showing the state in which gray is displayed by the display device shown in FIG. 1;

FIGS. 5A and 5B are side sectional views showing a first modification of the display device shown in FIG. 1;

FIGS. 6A and 6B are side sectional views showing a second modification of the display device shown in FIG. 1;

FIGS. 7A and 7B are side sectional views showing a third modification of the display device shown in FIG. 1;

FIG. 8 is a side sectional view showing a modification of the display device of FIG. 7 provided with partition walls;

FIG. 9A is a side sectional view showing the initial state of a display device constructed in accordance with a second embodiment of the present invention;

FIG. 9B is a side sectional view showing the state in which black is displayed by the display device shown in FIG. 9A;

FIG. 9C is a side sectional view showing the state in which white is displayed by the display device shown in FIG. 9A;

FIG. 9D is a side sectional view showing the state in which gray is displayed by the display device shown in FIG. 9A;

FIG. 10A is a side sectional view showing the initial state of a display device constructed in accordance with a third embodiment of the present invention;

FIG. 10B is a side sectional view showing the state in which gray is displayed by the display device shown in FIG. 10A;

FIG. 10C is a side sectional view showing the state in which black is displayed by the display device shown in FIG. 10A; and

FIGS. 11A and 11B are side sectional views showing a conventional display device.

### DESCRIPTION OF THE PREFERRED EMBODIMENTS

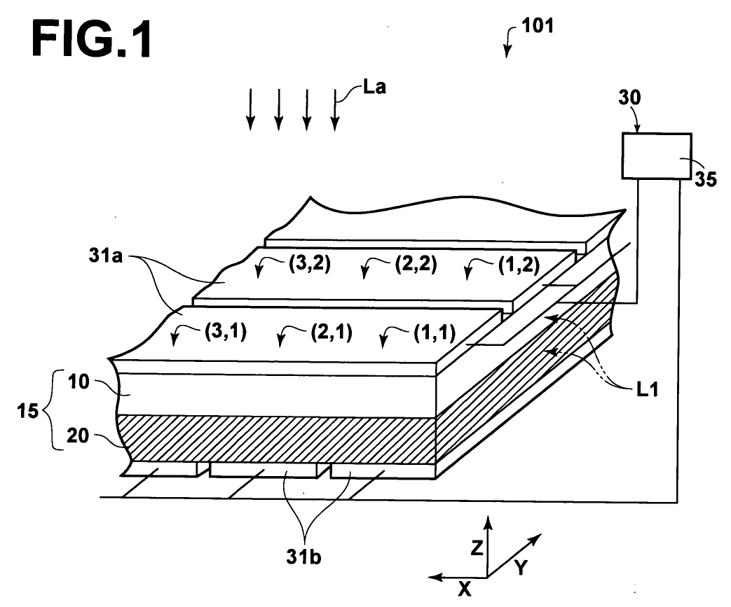

Referring to FIGS. 1 through 4, there is shown a display device 101 constructed in accordance with a first embodiment of the present invention.

The display device 101 is formed from a transparent material, and includes a transparent porous layer 10 with pores into which a penetrant L1 is penetrable; a colored layer 20 stacked on one surface of the transparent porous layer 10; and penetrant-moving means 30 for exerting the Coulomb force on the penetrant L1 to perform penetration of the penetrant L1 into the transparent porous layer 10 or discharge of the penetrant L1 from the transparent porous layer 10.

In the display device 101, when the penetrant L1 penetrates into the transparent porous layer 10, the transparent porous layer 10 becomes transparent and therefore the colored porous layer 20 is displayed through the transparent porous layer 10. On the other hand, when the penetrant L1 is discharged from the transparent porous layer 10, the transparent porous layer 10 becomes opaque and therefore the transparent porous layer 10 is displayed. The above-described display is performed by illuminating the transparent porous layer 10 of the display device 101 with light Lₐ. The surface of the display device 101 illuminated with light Lₐ will hereinafter be referred to as a screen.

The colored porous layer 20 is formed from a porous body into which the penetrant L1 is penetrable. When the penetrant L1 penetrates into the transparent porous layer 10 by the Coulomb force exerted on the penetrant L1 by the penetrant-moving means 30, the colored porous layer 20 supplies the penetrant L1 in the colored porous layer 20 to the transparent porous layer 10. When the penetrant L1 is discharged from the transparent porous layer 10, the colored porous layer 20 absorbs the discharged penetrant L1. The colored porous layer 20 can employ cellulose or acetyl cellulose. The colored porous layer 20 is colored black. For example, it can be colored by employing color ink, carbon black, etc.

The penetrant-moving means 30 consists of top electrodes 31a, bottom electrodes 31b, and a power supply 35. The top electrodes 31a are disposed on the top surface of a stacked structure 15 consisting of the transparent porous layer 10 and colored porous layer 20. The bottom electrodes 31b are disposed on the bottom surface of the stacked structure 15. The power supply 35 is a potential difference application part for applying a potential difference between the top electrodes 31a and the bottom electrodes 31b. The penetrant-moving means 30 exerts the Coulomb force on the penetrant L1 by forming an electric field in the direction of the thickness of the stacked structure 15. Note that the top electrodes 31a are arranged on the side of the transparent porous layer 10. Also, the bottom electrodes 31b are arranged on the side of the colored porous layer 20.

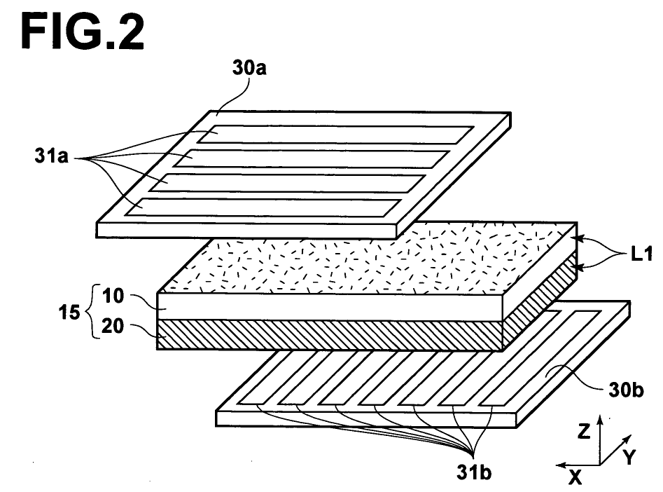

The top stripe electrodes 31a disposed on one surface (screen side) of the stacked structure 15, and the bottom stripe electrodes 31b disposed on the other surface of the stacked structure 15, are disposed to cross one another across the stacked structure 15. More specifically, the top stripe electrodes 31a and bottom stripe electrodes 31b are disposed on a top electrode-mounting panel 30a and bottom electrode-mounting panel 30b, which are in turn disposed on the top and bottom surfaces of the stacked structure 15 (see FIG. 2).

Each of the above-described stripe electrodes may use an electrode formed from a transparent material such as In₂O₃-SnO₂ (ITO) and ZnO. Also, the bottom stripe electrodes 31b may use electrodes formed from an opaque material such as Ni, Al, Pt, Ag, black lead, etc. Furthermore, the bottom stripe electrodes 31b may use transparent electrodes that are colored. The above-described electrodes may be formed, for instance, by a thin-film formation method such as sputtering. The thin-film formation method is capable of forming electrodes on the surfaces of the transparent porous layer 10 and colored porous layer 20 so the penetrant can pass through, without closing the pores in the two layers.

The penetrant-moving means 30 is capable of exerting the Coulomb forces of different magnitudes in the thickness direction (indicated by arrow Z) on the penetrant L1 present at positions different from one another in the layer direction (indicated by arrows X and Y). The penetrant-moving means 30 adopts a passive drive method of exerting the Coulomb forces of different magnitudes on the penetrant L1 present at different positions, through the top and bottom stripe electrodes 31a and 31b arranged in the form of a lattice with respect to the stacked structure 15. The different positions on the plane perpendicular to the thickness direction are positions at which the top stripe electrodes 31a and bottom stripe electrodes 31b cross one another in the form of a lattice. For example, these positions are indicated by position (1, 1), position (2, 1), position (3, 1), position (1, 2), position (2, 2), position (3, 2), etc.

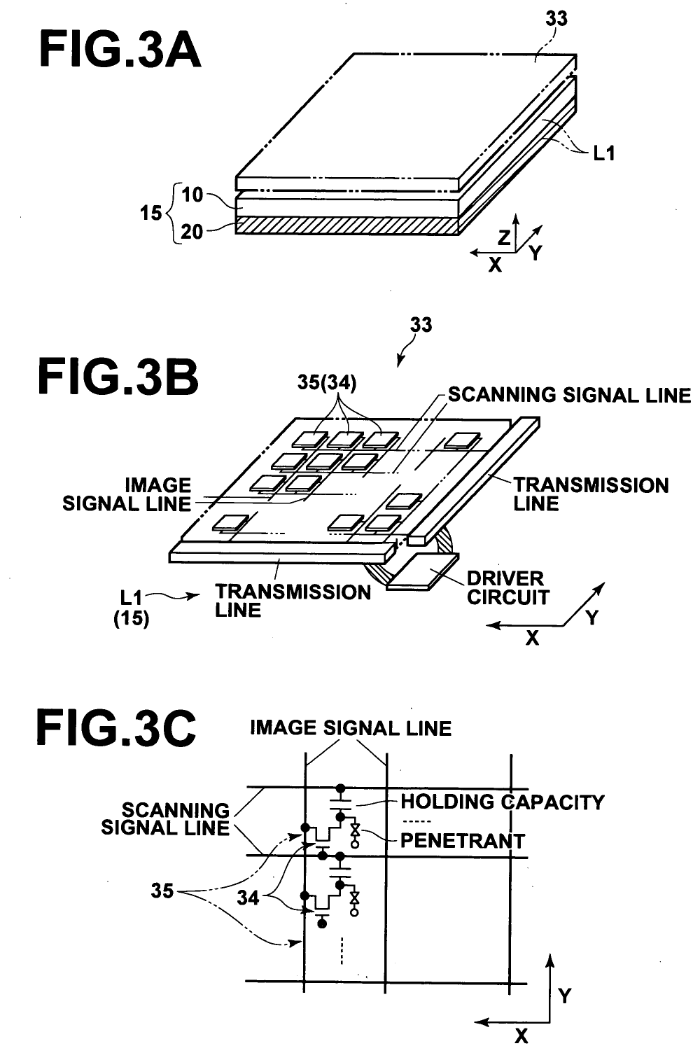

Note that the penetrant-moving means 30 may adopt a different method than the above-described drive method. For instance, the penetrant-moving means 30 may adopt an active drive method, as shown in FIGS. 3A to 3C. In the active drive method, an electrode panel 33 is mounted on one surface side (e.g., screen side) of the above-described stacked structure 15 and has a great number of electrodes 35, which are disposed in the form of a matrix and connected to thin-film transistors 34. The other surface side of the stacked structure 15 is grounded. The Coulomb forces different from one another are exerted on the penetrant L1 present at different positions, through the electrodes 35, by driving each thin-film transistor 34.

With adoption of the above-described penetrant-moving means, the colored porous layer 20 or transparent porous layer 10 can be displayed at an arbitrary position on the screen of the display device. This device is able to display a still picture image such as characters, figures, etc., and a motion picture image.

The penetrant L1 may be, for example, dimethyltriphenyltrimethoxysiloxane having a refractive index of 1. 51 (see Japanese Unexamined Patent Publication Nos. 60(1985)-6928 and 5(1993)-246021).

It is preferable that the transparent porous layer 10 employ a microporous membrane filter formed from a transparent resin material. A main material constituting the transparent resin material may be vinyl chloride, polypropylene, polyamide, polytetrafluorethylene, polyolefin, polysulfone, etc. It may also be a cellulosic material (such as cellulose nitrate, acetyl cellulose, and cellulose acetate), a ceramic material (such as alumina), glass fabric, etc. Furthermore, it may be a mixture of any two or more of resin, cellulosic, glass, and ceramic materials. Similarly, the colored porous layer 20 maybe formed by the same materials as the aforementioned materials.

In this embodiment, the transparent porous layer 10 is colorless and transparent. However, it maybe a colored layer if it is transparent.

It is preferable that the refractive index of the transparent porous layer 10 be close to that of the penetrant L1. That is, if both refractive indices are close to each other, the scattering, etc., of light passing through the transparent porous layer 10 can be reduced when the penetrant L1 has penetrated into the transparent porous layer 10, so the transparency of the transparent porous layer 10 into which the penetrant L1 has penetrated can be enhanced.

The capillary attraction of the colored porous layer 20 is greater than that of the transparent porous layer 10. When there is no potential difference between the top electrodes 31a and the bottom electrodes 31b, the penetrant L1 penetrates into the colored porous layer 20 whose capillary attraction is greater, and becomes stable. The capillary attraction can be expressed by the following Equation:
P=(2σcos θ)/r
in which

P: capillary attraction (Pa),

σ: surface tension (N/m),

θ: angle of contact between the liquid and the capillary interior wall (°),

r: radius of the capillary (mm).

In the above-described Equation, the capillary corresponds to a pore in the above-described porous layer. For example, when the above-described surface tension a and the angle of contact θ are the same between the transparent porous layer 10 and the colored porous layer 20, and the transparent porous layer 10 and the colored porous layer 20 are uniform in pore diameter, the capillary attraction of the colored porous layer 20 can be made greater than that of the transparent porous layer 10, if the pore diameter of the colored porous layer 20 is made smaller than that of the transparent porous layer 10.

It is preferable that the pore diameters of the transparent porous layer 10 and colored porous layer 20 be between 0.1 μm and 10 μm and further preferable that they be between 0.1 μm and 5 μm. If the pore diameter becomes small, the capillary attraction becomes great. As a result, since the resistance of the pore is increased when the penetrant is moved, the power supply 35 must consume more power when applying a potential difference between the above-described electrodes. On the other hand, if the pore diameter becomes great, light scattering at the transparent porous layer 10 is reduced and brightness is decreased, when the penetrant L1 is discharged from the transparent porous layer 10 to make the transparent porous layer 10 opaque.

It is also preferable that the thickness of the transparent porous layer 10 be between 10 μm and 200 μm. If the thickness is decreased, light passes through the transparent porous layer 10 even when the penetrant L1 is discharged from the transparent porous layer 10, and it becomes difficult to display the transparent porous layer 10 accurately. On the other hand, if the thickness is greater than 200 μm, the amount of the penetrant L1 to be moved in and out of the transparent porous layer 10 is increased and therefore the time required for moving the penetrant L1 becomes long.

Now, a description will be given of the operation of the display device constructed in accordance with the first embodiment of the present invention.

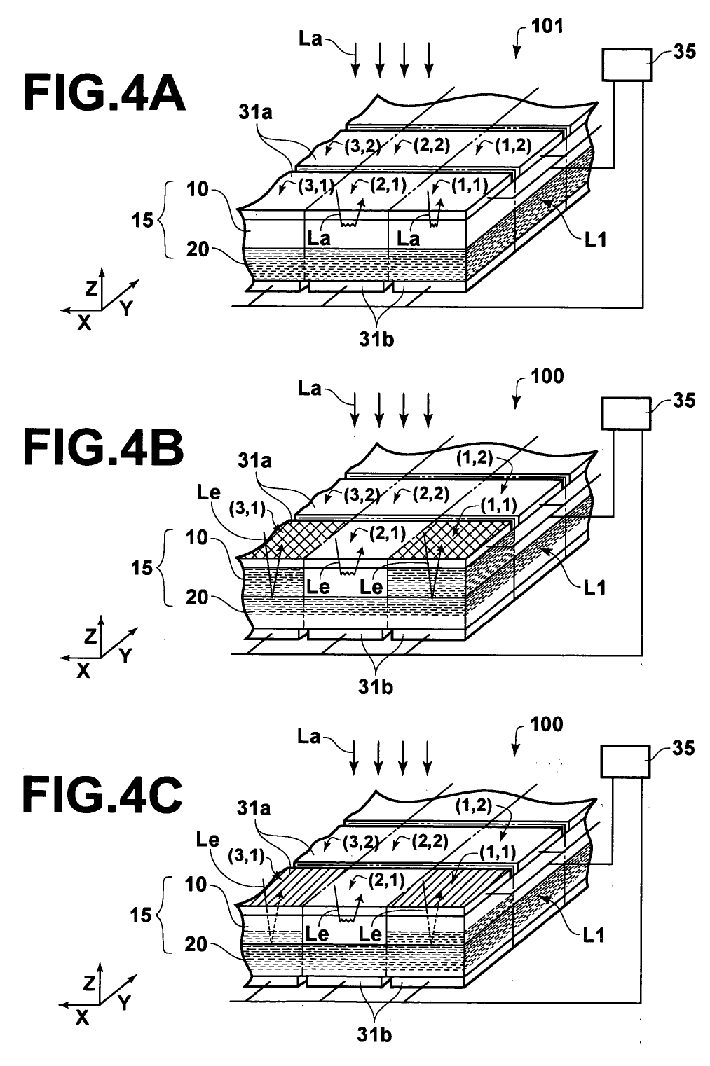

In the initial state where there is no potential difference across the stacked structure 15 consisting of the transparent porous layer 10 and colored porous layer 20, the penetrant L1 is discharged from the transparent porous layer 10 and penetrates into the colored porous layer 20 whose capillary attraction is great, as shown in FIG. 4A. In this state, if the transparent porous layer 10 is illuminated with light Lₐ, the light Lₐ is scattered at the transparent porous layer 10 and therefore the transparent porous layer 10 is displayed as opaque white.

When displaying black, the power supply 35 applies a potential difference between the top electrodes 31a and the bottom electrodes 31b, as shown in FIG. 4B. For example, when the potential difference is applied at positions (1, 1) and (3, 1), electric fields are formed in the corresponding portions of the stacked structure 15 in the thickness direction. As a result, the penetrant L1 in the colored porous layer 20 is moved into the transparent porous layer 10 by the Coulomb force, so the transparent porous layer 10 becomes transparent. At the positions (1, 1) and (3, 1), the colored porous layer 20 is displayed through the transparent porous layer 10 that became transparent by the illumination of light La. That is, black, which is the color of the colored porous layer 20, is displayed at the positions (1, 1) and (3, 1). On the other hand, at positions (2, 1), (1, 2), (2, 2), and (3, 2) where there is no potential difference between the top electrodes 31a and the bottom electrodes 31b, the penetrant L1 remains stayed in the colored porous layer 20 and therefore the transparent porous layer 10 is displayed.

When again displaying the entire surface of the screen in white, the application of the potential difference between the top electrodes 31a and the bottom electrodes 31b by the power supply 35 is stopped (potential difference is made zero). As a result, the penetrant L1 is moved from the transparent porous layer 10 into the colored porous layer 20 by capillary attraction, and in the same manner as described above, the transparent porous layer 10 is displayed in white (see FIG. 4A).

When displaying gray, a potential difference, smaller than the potential difference applied in displaying black, is applied between the top electrodes 31a and the bottom electrodes 31b by the power supply 35. For example, when the smaller potential difference is applied at positions (1, 1) and (3, 1) in FIG. 4C, electric fields are formed in the direction of the thickness of the stacked structure 15, and the penetrant L1 in the colored porous layer 20 is moved into the transparent porous layer 10 by the Coulomb forces. However, if the Coulomb forces of moving the penetrant L1 into the transparent porous layer 10 become equal to the capillary attraction of attracting the penetrant L1 into the colored porous layer 20, the movement of the penetrant L1 from colored porous layer 20 into the transparent porous layer 10 is stopped and the transparent porous layer 10 becomes semitransparent at the positions (1, 1) and (3, 1). Therefore, the black of the colored porous layer 20 is displayed through the transparent porous layer 10 that became semitransparent at the positions (1, 1) and (3, 1). In this way, gray is displayed.

Thus, the display of the display device 101 can be variously changed by applying the above-described potential difference with the power supply 35.

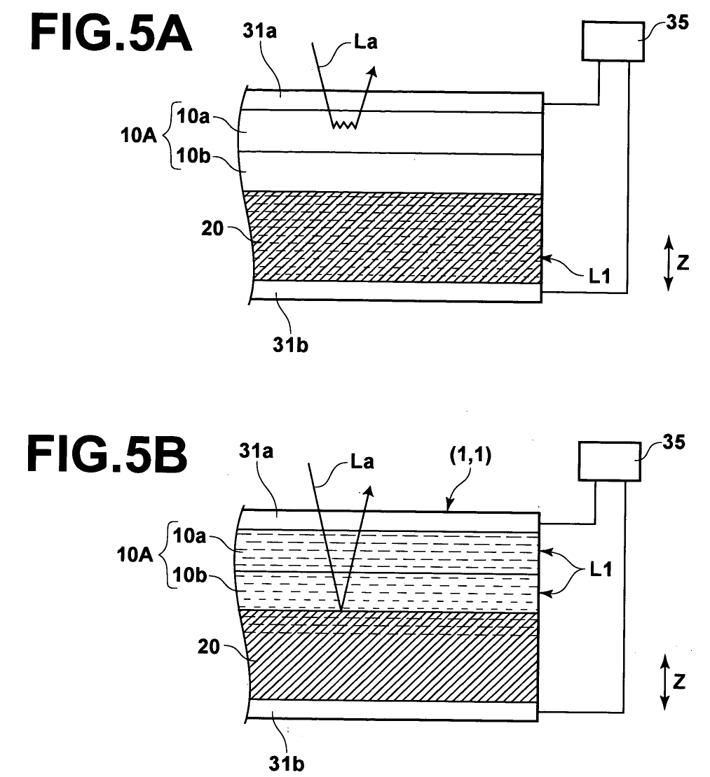

Referring to FIGS. 5A and 5B, there is shown a first modification of the display device 101 constructed in accordance with the first embodiment of the present invention.

In the first modification, the transparent porous layer 10 of the display device 101 of FIGS. 1 to 4 is improved so that the diameter of each pore in the transparent porous layer 10 becomes larger the further it is away from the colored porous layer 20 in the thickness direction. More particularly, as shown in FIGS. 5A and 5B, a transparent porous layer 10A in the first modification consists of a first transparent porous layer 10a with a great pore diameter disposed on the side of light Lₐ, and a second transparent porous layer 10b with a small pore diameter disposed on the side of the colored porous layer 20. The first transparent porous layer 10a is stacked on the second transparent porous layer 10b. The remaining structure is the same as the display device 101 of the first embodiment of FIGS. 1 to 4. In the following description, the same reference numerals will be applied to the same parts as the first embodiment. Therefore, detailed descriptions there of will be omitted unless particularly necessary. Note that because the pore diameter of the colored porous layer 20 is smaller than that of the transparent porous layer 10b, the pore diameter of the colored porous layer 20 is smaller than that of the transparent porous layer 10A.

Now, a description will be given of the operation of the display device of the first modification shown in FIGS. 5A and 5B.

In the initial state where there is no potential difference between the top electrodes 31a and the bottom electrodes 31b, the penetrant L1 is discharged from the transparent porous layer 10A and penetrates into the colored porous layer 20, as shown in FIG. 5A. In this state, if the transparent porous layer 10A is illuminated with light Lₐ, the transparent porous layer 10A is displayed in white, as with the first embodiment of FIGS. 1 to 4.

When displaying black, the power supply 35 applies a potential difference between the top electrodes 31a and the bottom electrodes 31b, as shown in FIG. 5B. With the application of the potential difference, an electric field is formed in the thickness direction of the stacked structure 15. As a result, the penetrant L1 in the colored porous layer 20 is moved into the transparent porous layer 10A by the Coulomb force, so the transparent porous layer 10 is filled with the penetrant L1 and becomes transparent. Because the colored porous layer 20 is displayed through the transparent porous layer 10A, black is displayed.

When displaying white again, the potential difference between the top electrodes 31a and the bottom electrodes 31b is made 0 V by the power supply 35. As a result, the penetrant L1 is moved from the transparent porous layer 10A into the colored porous layer 20 by capillary attraction, and in the same manner as described above, the transparent porous layer 10A is displayed in white (see FIG. 5A). When the penetrant L1 penetrates into the transparent porous layer 10b whose pore diameter is small, resistance to the small pore is great. On the other hand, when the penetrant L1 penetrates into the transparent porous layer 10a whose pore diameter is large, resistance to the large pore is small. Therefore, during the period from the movement of the penetrant L1 into the colored porous layer 20 to the display (white) of the transparent porous layer 10A, display is properly changed. Also, during the period from the movement of the penetrant L1 into the transparent porous layer 10A to the display of the colored porous layer 20, display is properly changed. Therefore, when a specified brightness is shifted to brightness different from that brightness, the afterimage of the display can be optimized. That is, when the penetrant L1 in the colored porous layer 20 penetrates into the transparent porous layer 10A by the application of a potential difference between the top electrodes 31a and the bottom electrodes 31b, the second transparent porous layer 10b plays a role of preventing the moving time of the penetrant L1 from becoming too short. Also, when the penetrant L1 in the transparent porous layer 10A is moved into the colored porous layer 20 by making the above-described potential difference 0 V, the transparent porous layer 10b fulfills its role as resistance and prolongs the moving time of the penetrant L1, so display can have an afterimage (memory effect). The transparent porous layer 10b is sufficiently thinner in thickness than the other layers and is smallest in pore diameter.

The structure of making the pore diameter of each pore in the transparent porous layer 10A larger the further it is away from the colored porous layer 20 in the thickness direction is not limited to the above-described structure consisting of two layers which are different from each other in pore diameter, but may be a structure consisting of three or more layers, or a structure whose pore diameter changes continuously in the thickness direction.

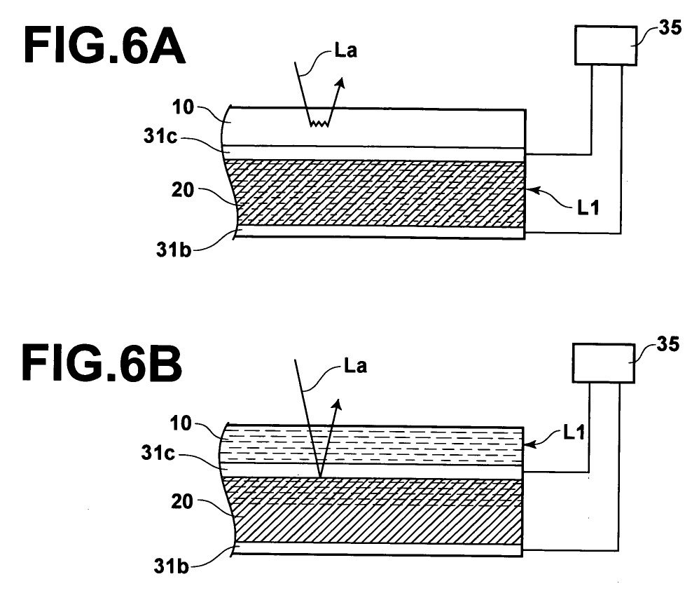

Referring to FIGS. 6A and 6B, there is shown a second modification of the display device 101 constructed in accordance with the first embodiment of the present invention.

In the second modification, the power supply 35 of the display device 101 of FIGS. 1 to 4 is improved to apply a potential difference between the electrodes disposed on the top and bottom surfaces of the colored porous layer 20. More particularly, as shown in FIGS. 6A and 6B, penetrant-moving means has top electrodes 31c and bottom electrodes 31b disposed on the top and bottom surfaces of the colored porous layer 20. The power supply 35 applies a potential difference between the top electrodes 31c and the bottom electrodes 31b to exert the Coulomb forces on a penetrant L1. The remaining structure is the same as the display device 101 of the first embodiment of FIGS. 1 to 4. In the following description, the same reference numerals will be applied to the same parts as the first embodiment. Therefore, detailed descriptions thereof will be omitted unless particularly necessary. Note that the top electrodes 31c are arranged on the top surface of the colored porous layer 20 that is on the side of the transparent porous layer 10. Also, the bottom electrodes 31b are arranged on the bottom surface of the colored porous layer 20 remote from the transparent porous layer 10. The top electrodes 31c are transparent electrodes through which the penetrant L1 can pass.

Now, a description will be given of the operation of the display device of the second modification shown in FIGS. 6A and 6B.

In the initial state where there is no potential difference between the top electrodes 31c and the bottom electrodes 31b, the penetrant L1 is discharged from the transparent porous layer 10 and penetrates into the colored porous layer 20 (where pore diameter is small and capillary attraction is great, compared to the transparent porous layer 10), as shown in FIG. 6A. In this state, if the transparent porous layer 10 is illuminated with light Lₐ, the transparent porous layer 10 is displayed in white, as with the first embodiment of FIGS. 1 to 4.

When displaying black, the power supply 35 applies a potential difference between the top electrodes 31c and the bottom electrodes 31b, as shown in FIG. 6B. With the potential difference, an electric field is formed in the thickness direction of the colored porous layer 20. As a result, the penetrant L1 in the colored porous layer 20 is moved into the transparent porous layer 10 by the Coulomb force, so the transparent porous layer 10 is filled with the penetrant L1 and becomes transparent. Because the colored porous layer 20 is displayed through the transparent porous layer 10, black is displayed.

When displaying white again, the potential difference between the top electrodes 31c and the bottom electrodes 31b is made 0 V by the power supply 35. As a result, the penetrant L1 is moved from the transparent porous layer 10 into the colored porous layer 20 by capillary attraction, and in the same manner as described above, the transparent porous layer 10 is displayed in white (see FIG. 6A).

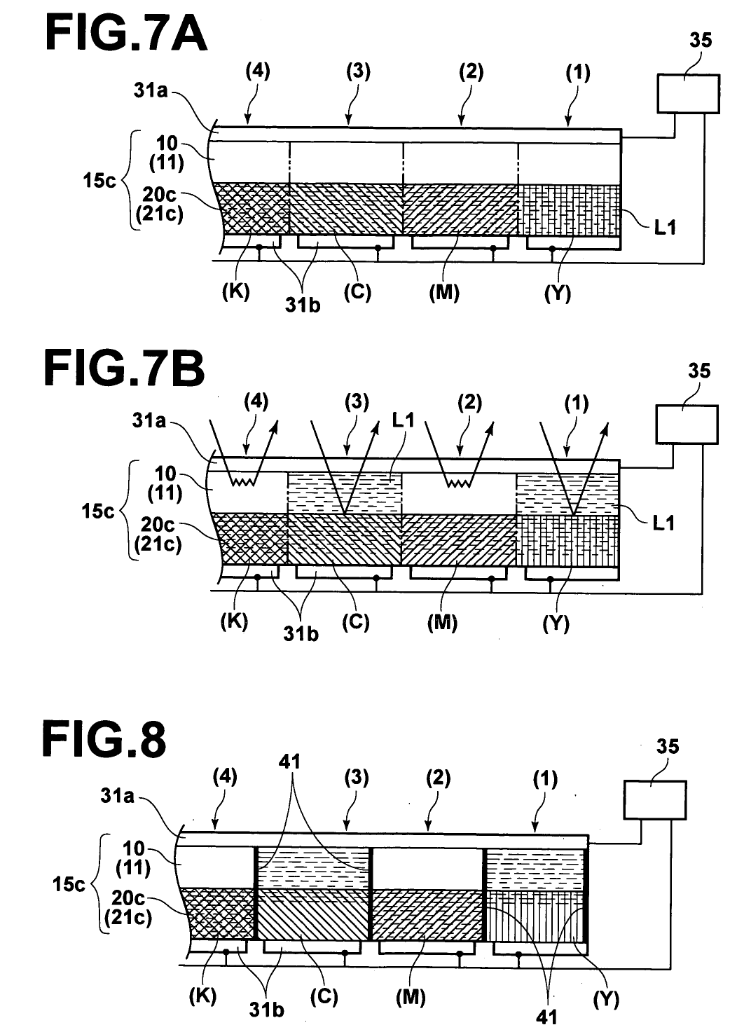

Referring to FIGS. 7A and 7B, there is shown a third modification of the display device 101 constructed in accordance with the first embodiment of the present invention.

In the third modification, the display device 101 of FIGS. 1 to 4 is improved so it can display colors. As shown in FIGS. 7A and 7B, a colored porous layer 20 is colored yellow (Y), magenta (M), cyan (C), and black (K) at positions (1), (2), (3), and (4), which are different from one another, on the plane perpendicular to the thickness direction. At the different positions (1), (2), (3), and (4), the power supply 35 is able to exert the Coulomb forces different from one another, on the penetrant L1. The remaining structure is the same as the display device 101 of the first embodiment of FIGS. 1 to 4. In the following description, the same reference numerals will be applied to the same parts as the first embodiment. Therefore, detailed descriptions thereof will be omitted unless particularly necessary.

Now, a description will be given of the operation of the display device of the third modification shown in FIGS. 7A and 7B.

In the initial state where there is no potential difference between the top electrodes 31a and bottom electrodes 31b disposed on the top and bottom surfaces of a stacked structure 15C consisting of a transparent porous layer 10 and a colored porous layer 20C, the penetrant L1 is discharged from the transparent porous layer 10 and penetrates into the colored porous layer 20, as shown in FIG. 7A. In this state, if the transparent porous layer 10 is illuminated with light La, the transparent porous layer 10 is displayed in white.

For instance, when displaying yellow (Y) and cyan (C), the power supply 35 applies a potential difference between the top electrodes 31a and the bottom electrodes 31b at the positions (1) and (3) corresponding to the yellow (Y) and cyan (C) in the stacked structure 15C. The application of the potential difference causes electric fields to be generated at the positions (1) and (3) in the thickness direction of the stacked structure 15C. As a result, at the positions (1) and (3), the penetrant L1 in the colored porous layer 20C is moved into the transparent porous layer 10, and the transparent porous layer 10 becomes transparent. Therefore, at the positions (1) and (3), the colored porous layer 20C colored yellow (Y) and cyan (C) is displayed through the transparent porous layer 10. On the other hand, at the positions (2) and (4) corresponding to magenta (M) and black (K), the display device remains displayed in white because there is no potential difference between the top electrodes 31a and the bottom electrodes 31b.

When displaying white at the positions (1) and (3) again, the potential difference between the electrodes corresponding to those positions is made 0 V. As a result, the penetrant L1 in the transparent porous layer 10 is moved into the colored porous layer 20C by capillary attraction, and white is displayed at the positions (1) and (3) (see FIG. 7A).

Note that the third modification maybe further improved. As shown in FIG. 8, the stacked structure 15C may be provided with partition walls 41, which extend in the thickness direction to individually separate the positions (1), (2), (3), and (4). These partition walls 41 prevent the penetrant L1 from passing through them. Therefore, at the positions (1), (2), (3), and (4), the penetration of the penetrant L1 into the transparent porous layer 10 and discharge of the penetrant L1 from the transparent porous layer 10 can be distinctly performed. Thus, displaying can be performed with the contour of each area emphasized.

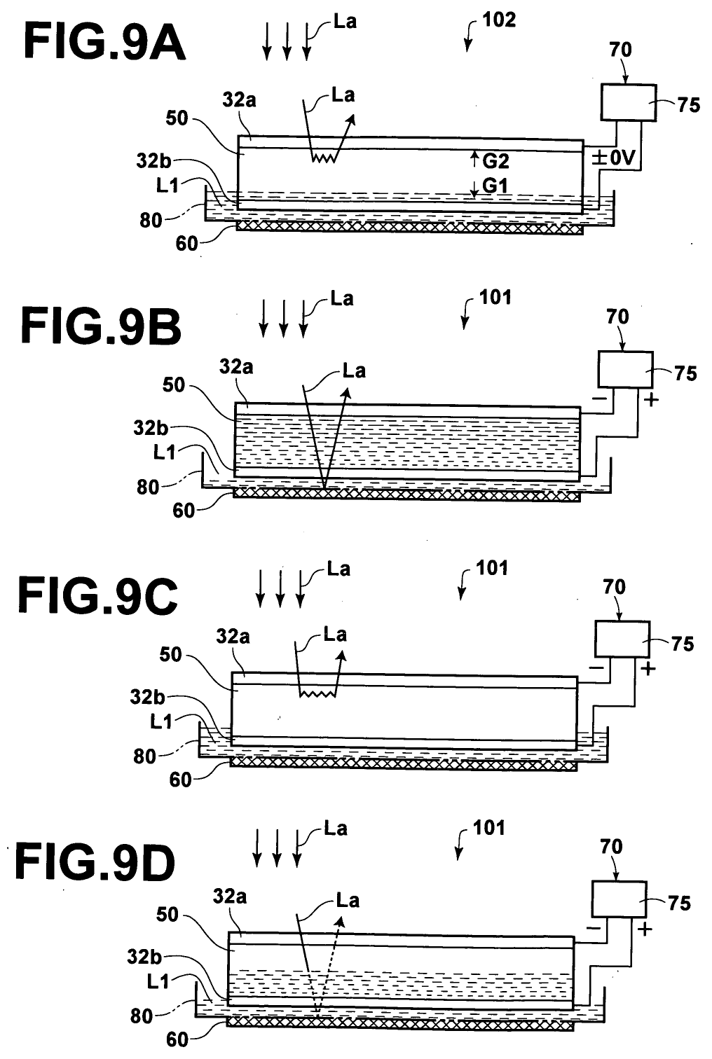

Referring to FIG. 9, there is shown a display device 102 constructed in accordance with a second embodiment of the present invention.

The display device 102 is formed from a transparent material, and includes a transparent porous layer 50 with pores into which a penetrant L1 is penetrable; a colored layer 60 stacked on one surface of the transparent porous layer 50; penetrant-moving means 70 for exerting the Coulomb force on the penetrant L1 to perform penetration of the penetrant L1 into the transparent porous layer 50 or discharge of the penetrant L1 from the transparent porous layer 50; and a penetrant storage layer 80 for storing the penetrant L1 between the transparent porous layer 50 and the colored layer 60.

In the display device 102, when the penetrant L1 penetrates into the transparent porous layer 50, the transparent porous layer 50 becomes transparent and therefore the colored porous layer 60 is displayed through the transparent porous layer 50. On the other hand, when the penetrant L1 is discharged from the transparent porous layer 50, the transparent porous layer 50 becomes opaque and therefore the transparent porous layer 50 is displayed. The above-described display is performed by illuminating the transparent porous layer 50 of the display device 102 with light Lₐ. The surface of the display device 102 illuminated with light Lₐ will hereinafter be referred to as the screen.

Note that the colored layer 60 is constructed of a black light-absorbing layer of resin.

When the penetrant L1 is moved into the transparent porous layer 50 by the Coulomb force exerted on the penetrant L1 by the penetrant-moving means 70, the penetrant storage layer 80 supplies the penetrant L1 to the transparent porous layer 50. Also, when the penetrant L1 is discharged from the transparent porous layer 50, the penetrant storage layer 80 stores the discharged penetrant L1.

The penetrant-moving means 70 consists of top electrodes 31a, bottom electrodes 31b, and a power supply 75. The top electrodes 31a and bottom electrodes 31b are disposed on the top and bottom surfaces of the transparent porous layer 50, respectively. The power supply 75 is a potential difference application part for applying a potential difference between the top electrodes 31a and the bottom electrodes 31b, forming an electric field, and exerting the Coulomb force on the penetrant L1. Note that the top electrodes 31a are arranged on the top surface of the transparent porous layer 50. Also, the bottom electrodes 31b are arranged on the bottom surface of the transparent porous layer 50 that is on the side of the penetrant storage layer 80.

In the transparent porous layer 50, the pore diameter becomes larger the further it is away from the colored layer 60. The average value of pore diameters in the vicinity of the top electrodes 32a disposed on the screen side of the transparent porous layer 50 is 2 μm, while the average value of pore diameters near the bottom electrodes 32b disposed on the bottom surface of the transparent porous layer 50 is 0.3 μm. Also, the thickness of the transparent porous layer 50 is 80 μm.

The remaining structure is the same as the first embodiment of FIGS. 1 to 4.

Next, a description will be given of the operation of the display device 102 of the second embodiment constructed as described above.

In the initial state where there is no potential difference across the transparent porous layer 50, the penetrant L1 is stored in the penetrant storage layer 80, as shown in FIG. 9A. In the transparent porous layer 50, the penetrant L1 has penetrated on a side of the transparent porous layer 50 near the penetrant storage layer 80 in which the pore diameter is small and capillary attraction is great (this side, indicated by arrow G1, will hereinafter be referred to as the small-diameter side). Also, on the screen side of the transparent porous layer 50 where the pore diameter is large and capillary attraction is small (this side indicated by arrow G2 will hereinafter be referred to as the large-diameter side), the penetrant L1 has been discharged. In this state, if the transparent porous layer 50 is illuminated with light Lₐ, the light Lₐ incident on the transparent porous layer 50 is scattered at the region on the large-diameter side of the transparent porous layer 50 and therefore the transparent porous layer 50 becomes opaque and is displayed in white.

When displaying black, the power supply 75 applies a potential difference of 100 V between the top electrodes 32a and the bottom electrodes 32b, as shown in FIG. 9B. The application of the potential difference causes an electric field to be generated across the transparent porous layer 50. The penetrant L1 in the penetrant storage layer 80 is moved into the transparent porous layer 50 by the Coulomb force exerted on the transparent porous layer 50, so the transparent porous layer 50 is filled with the penetrant L1 and becomes transparent. Thus, the colored layer 60 is displayed and black is displayed.

When displaying white, the potential difference between the top electrodes 32a and the bottom electrodes 32b that is applied by the power supply 35 is made opposite in polarity to the case of displaying black, as shown in FIG. 9C. The application of the opposite potential difference causes the Coulomb force to be exerted on the penetrant L1 in the transparent porous layer 50, so the penetrant L1 is moved into the penetrant storage layer 80. Because the penetrant L1 is discharged from the transparent porous layer 50, the transparent porous layer 50 is displayed in white, as described above. Note that if the potential difference across the transparent porous layer 50 is made 0 V after the discharge of the penetrant L1 from the transparent porous layer 50, the penetrant L1 is moved into the small-diameter side of the transparent porous layer 50 by capillary attraction and is caused to be in the same state as the initial state.

When displaying gray from the above-described state in which white is displayed, the power supply 75 applies a potential difference, which is the same polarity as when displaying black but smaller than when displaying black, between the top electrodes 32a and the bottom electrodes 32b, as shown in FIG. 9D. With application of the potential difference, an electric field is generated in the transparent porous layer 50 and the Coulomb force is exerted on the penetrant L1, so the penetrant L1 is moved toward the large-diameter side of the transparent porous layer 50. However, since the penetration of the penetrant L1 into the transparent porous layer 50 is stopped without being completely filled with the penetrant L1, scattering of light Lₐ occurs more or less on the large-diameter side of the transparent porous layer 50. Therefore, the transparent porous layer 50 becomes semitransparent. Thus, since the colored layer 60 which is black is displayed through the transparent porous layer 50 made semitransparent, gray is displayed.

Note that the transparent porous layer 50 is not limited to the case where the pore diameter in the transparent porous layer 50 is larger the further it is away from the colored layer 60 in the thickness direction. For instance, even when the pore diameter in the transparent porous layer 50 is uniform regardless of the pore position, displaying can be performed in approximately the same manner in the case other than the initial state. That is, in the initial state where the potential difference between the top electrodes 32a and the bottom electrodes 32b is 0 V, the penetrant L1 penetrates uniformly into the transparent porous layer 50 by capillary attraction. Therefore, since scattering of light Lₐ on the large-diameter side of the transparent porous layer 50 is reduced and the transparent porous layer 50 becomes semitransparent, the colored layer 60 that is black is also displayed through the transparent porous layer 50 made semitransparent. Therefore, in this case, brightness is reduced, compared to the white of the initial state in the case where pore diameter changes in the thickness direction.

Note that the penetrant-moving means may be made up of electrodes, which are respectively disposed on the top and bottom surfaces of a stacked structure consisting of the transparent porous layer and penetrant storage layer, and a power source for applying a potential difference between the electrodes.

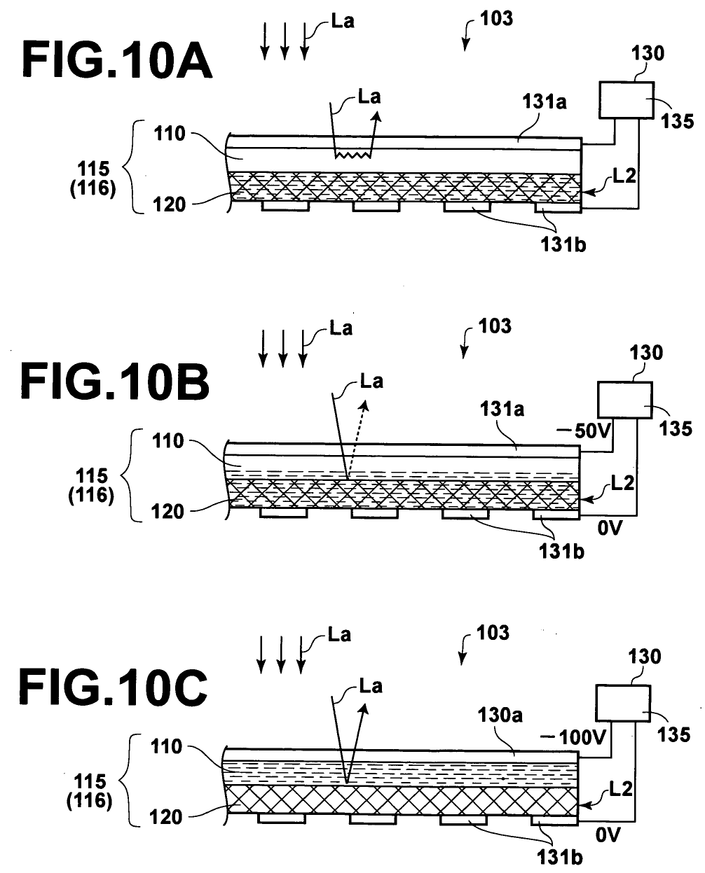

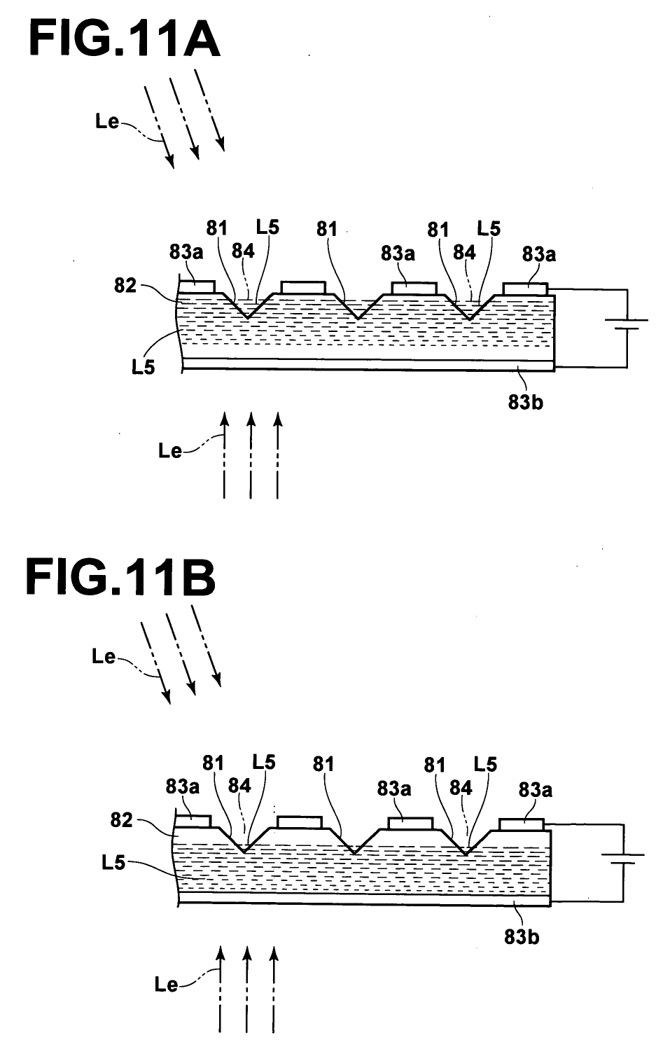

Referring to FIGS. 10A through 10D, there is shown a display device 103 constructed in accordance with a third embodiment of the present invention.

The display device 103 of the third embodiment is formed from a transparent material, and includes a transparent porous layer 110 with pores into which a penetrant L1 is penetrable; a colored porous layer 120 stacked on one surface of the transparent porous layer 110; and penetrant-moving means 30 for exerting the Coulomb force on the penetrant L1 to perform penetration of the penetrant L1 into the transparent porous layer 110 or discharge of the penetrant L1 from the transparent porous layer 110.

In the display device 103, when the penetrant L1 penetrates into the transparent porous layer 110, the transparent porous layer 110 becomes transparent and therefore the colored porous layer 120 is displayed through the transparent porous layer 110. On the other hand, when the penetrant L1 is discharged from the transparent porous layer 110, the transparent porous layer 110 becomes opaque and therefore the transparent porous layer 110 is displayed. These displays are performed by illuminating the transparent porous layer 110 with light Lₐ. The surface of the display device 103 illuminated with light Lₐ will be referred to as the screen.

The stacked structure 115, consisting of the transparent porous layer 110 and colored porous layer 120, is formed in the following manner, with a homogeneous porous panel 116 as a base.

That is, the porous panel 116 employs a microporous nitrocellulose material with a thickness of 80 μm, an average pore diameter of 5 μm, and an refractive index of 1.51. Initially, top stripe electrodes 131a and bottom stripe electrodes 131b are respectively disposed on the top and bottom surfaces of the porous panel 116 so that they cross one another across the porous panel 116. The top stripe electrodes 131a and bottom stripe electrodes 131b are formed as transparent electrodes of thickness 200 nm consisting of In₂O₃-SnO₂ (ITO) by sputtering. Note that the top stripe electrodes 131a and bottom stripe electrodes 131b, formed to cross one another across the porous panel 116, may be the same electrodes as the first embodiment.

Next, the transparent porous layer 110 is formed in the porous panel 116. The side of the top electrodes 131a of the porous panel 116 is coated with a water-repellent and oil-repellent coating (SAITOP made by Asahi Glass) with a surface tension of 19 N/m so that the coating penetrates to a depth of 40 μm. In this way, the transparent porous layer 110 is formed in the region from the top surface of the porous panel 116 to depth 40 μm.

Subsequently, the colored porous layer 120 is formed in the porous panel 116. The side of the bottom electrodes 131b of the porous panel 116 is coated with ink containing carbon black as a pigment (GA Black 1), the ink penetrates to a depth of 40 μm, and the porous panel 116 is colored black. In this way, the colored porous layer 120 is formed in the region from the bottom surface of the porous panel 116 to depth 40 μm.

With formation of the stacked structure 115, the electrodes disposed on the side of the transparent porous layer 110 are formed as the top electrodes 131a. The electrodes arranged on the side of the colored porous layer 120 are formed as the bottom electrodes 131b. The side of the top electrodes 131a is formed as the screen.

The penetrant-moving means 130 has the top electrodes 131a and 131b respectively disposed on the transparent porous layer 110 and colored porous layer 120, and a power supply 135. The power supply 135 is a potential difference application part to exert the Coulomb force on the penetrant L2 by applying a potential difference between the top and bottom electrodes 131a and 131b.

Note that the penetrant L2 is composed of dimethyltriphenyltrimethoxysiloxane, having a refractive index of 1. 51.

A description will hereinafter be given of the operation of the display device 103 constructed as described above.

When the power supply 135 applies no potential difference between the top and bottom electrodes 131a and 131b, the penetrant L2 is more stably present in the black-colored porous layer 120 than in the transparent porous layer 110, as shown in FIG. 10A. In this state, if the transparent porous layer 110 is illuminated with light Lₐ, the light Lₐ is scattered within the transparent porous layer 110 and therefore the transparent porous layer 110 is displayed as opaque white.

When the power supply 135 applies 0 V to the bottom electrodes 131b and −50 V to the top electrodes 131a, the penetrant L2 is attracted toward the top electrodes 131a and penetrates into a portion of the transparent porous layer 110. As a result, scattering of the light Lₐ in the transparent porous layer 110 is reduced and the transparent porous layer 110 becomes semitransparent. Because the black-colored porous layer 120 is displayed through the transparent porous layer 110, which is made semitransparent, gray is displayed.

When the power supply 135 applies 0 V to the bottom electrodes 131b and −100 V to the top electrodes 131a, the penetrant L2 is further attracted toward the top electrodes 131a and penetrates into approximately the entire surface of the transparent porous layer 110. As a result, there is no scattering of the light Lₐ in the transparent porous layer 110 and the transparent porous layer 110 becomes transparent. Since the black-colored porous layer 120 is displayed through the transparent porous layer 110, which is made transparent, black is displayed.

Thus, the display device 103 is capable of displaying white, gray, and black by changing a potential difference between the top and bottom electrodes 131a and 131b by the penetrant-moving means 130.

While the present invention has been described with reference to the preferred embodiments thereof, the invention is not to be limited to the details given herein, but may be modified within the scope of the invention hereinafter claimed. For example, although the supply of the penetrant to the transparent porous layer and the absorption of the penetrant discharged from the transparent porous layer are performed by the penetrant storage layer or colored porous layer, the structure of performing the supply and absorption of the penetrant may be any structure, so long as it is able to supply and absorb the penetrant.

1. A display device comprising:
a transparent porous layer, formed from a transparent material, which has pores into which a penetrant is penetrable;
a colored layer stacked on one surface of said transparent porous layer; and
penetrant-moving means for performing penetration of said penetrant into said transparent porous layer or discharge of said penetrant from said transparent porous layer;
wherein, after the penetration of said penetrant into said transparent porous layer performed by said penetrant-moving means, said transparent porous layer becomes transparent and therefore said colored layer is displayed through said transparent porous layer;
and wherein, after the discharge of said penetrant from said transparent porous layer performed by said penetrant-moving means, said transparent porous layer becomes opaque and therefore said transparent porous layer is displayed.

2. The display device as set forth in claim 1, wherein
said colored layer is a colored porous layer with pores into which said penetrant is penetrable;
when said penetrant penetrates into said transparent porous layer, said colored porous layer supplies said penetrant from said colored porous layer to said transparent porous layer; and
when said penetrant is discharged from said transparent porous layer, said colored porous layer absorbs said discharged penetrant.

3. The display device as set forth in claim 2, wherein said penetrant-moving means comprises:
electrodes, which are respectively disposed on top and bottom surfaces of a stacked structure comprising said transparent porous layer and colored porous layer; and
a potential difference application part for applying a potential difference between said electrodes disposed on the top and bottom surfaces of said stacked structure.

4. The display device as set forth in claim 2, wherein said penetrant-moving means comprises:
electrodes, which are respectively disposed on top and bottom surfaces of said colored porous layer; and
a potential difference application part for applying a potential difference between said electrodes disposed on the top and bottom surfaces of said colored porous layer.

5. The display device as set forth in claim 2, wherein capillary attraction, which is produced in said colored porous layer when said penetrant penetrates into said colored porous layer, is greater than that of said transparent porous layer.

6. The display device as set forth in claim 3, wherein capillary attraction, which is produced in said colored porous layer when said penetrant penetrates into said colored porous layer, is greater than that of said transparent porous layer.

7. The display device as set forth in claim 4, wherein capillary attraction, which is produced in said colored porous layer when said penetrant penetrates into said colored porous layer, is greater than that of said transparent porous layer.

8. The display device as set forth in claim 1, further comprising a transparent penetrant storage layer, interposed between said transparent porous layer and said colored layer, for storing said penetrant;
wherein, when said penetrant penetrates into said transparent porous layer, said penetrant storage layer supplies said penetrant from said penetrant storage layer to said transparent porous layer;
and wherein, when said penetrant is discharged from said transparent porous layer, said penetrant storage layer stores the discharged penetrant.

9. The display device as set forth in claim 8, wherein said penetrant-moving means comprises:
electrodes, which are respectively disposed on the top and bottom surfaces of said transparent porous layer; and
a potential difference application part for applying a potential difference between said electrodes disposed on the top and bottom surfaces of said transparent porous layer.

10. The display device as set forth in claim 1, wherein a pore diameter in said transparent porous layer becomes greater the further it is away from said colored layer in the direction of the thickness of the two layers.

11. The display device as set forth in claim 2, wherein a pore diameter in said transparent porous layer becomes greater the further it is away from said colored layer in the direction of the thickness of the two layers.

12. The display device as set forth in claim 3, wherein a pore diameter in said transparent porous layer becomes greater the further it is away from said colored layer in the direction of the thickness of the two layers.

13. The display device as set forth in claim 4, wherein a pore diameter in said transparent porous layer becomes greater the further it is away from said colored layer in the direction of the thickness of the two layers.

14. The display device as set forth in claim 5, wherein a pore diameter in said transparent porous layer becomes greater the further it is away from said colored layer in the direction of the thickness of the two layers.

15. The display device as set forth in claim 8, wherein a pore diameter in said transparent porous layer becomes greater the further it is away from said colored layer in the direction of the thickness of the two layers.

16. The display device as set forth in claim 1, wherein a pore diameter in said transparent porous layer is between 0.1 μm and 10 μm and, when said colored layer is said colored porous layer, a pore diameter in said colored porous layer is between 0.1 μm and 10 μm.

17. The display device as set forth in claim 2, wherein a pore diameter in said transparent porous layer is between 0.1 μm and 10 μm and, when said colored layer is said colored porous layer, a pore diameter in said colored porous layer is between 0.1 μm and 10 μm.

18. The display device as set forth in claim 3, wherein a pore diameter in said transparent porous layer is between 0.1 μm and 10 μm and, when said colored layer is said colored porous layer, a pore diameter in said colored porous layer is between 0.1 μm and 10 μm.

19. The display device as set forth in claim 4, wherein a pore diameter in said transparent porous layer is between 0.1 μm and 10 μm and, when said colored layer is said colored porous layer, a pore diameter in said colored porous layer is between 0.1 μm and 10 μm.

20. The display device as set forth in claim 5, wherein a pore diameter in said transparent porous layer is between 0.1 μm and 10 μm and, when said colored layer is said colored porous layer, a pore diameter in said colored porous layer is between 0.1 μm and 10 μm.

21. The display device as set forth in claim 8, wherein a pore diameter in said transparent porous layer is between 0.1 μm and 10 μm and, when said colored layer is said colored porous layer, a pore diameter in said colored porous layer is between 0.1 μm and 10 μm.

22. The display device as set forth in claim 1, wherein said colored layer is colored black.

23. The display device as set forth in claim 1, wherein said penetrant-moving means exerts the Coulomb forces of different magnitudes on said penetrant in said thickness direction at different positions on a plane perpendicular to said thickness direction.

24. The display device as set forth in claim 2, wherein said penetrant-moving means exerts the Coulomb forces of different magnitudes on said penetrant in said thickness direction at different positions on a plane perpendicular to said thickness direction.

25. The display device as set forth in claim 3, wherein said penetrant-moving means exerts the Coulomb forces of different magnitudes on said penetrant in said thickness direction at different positions on a plane perpendicular to said thickness direction.

26. The display device as set forth in claim 4, wherein said penetrant-moving means exerts the Coulomb forces of different magnitudes on said penetrant in said thickness direction at different positions on a plane perpendicular to said thickness direction.

27. The display device as set forth in claim 5, wherein said penetrant-moving means exerts the Coulomb forces of different magnitudes on said penetrant in said thickness direction at different positions on a plane perpendicular to said thickness direction.

28. The display device as set forth in claim 8, wherein said penetrant-moving means exerts the Coulomb forces of different magnitudes on said penetrant in said thickness direction at different positions on a plane perpendicular to said thickness direction.

29. The display device as set forth in claim 23, wherein said colored layer is colored in different hues at different positions on a plane perpendicular to said thickness direction.

30. The display device as set forth in claim 29, wherein said different hues are yellow, magenta, cyan, and black.

31. The display device as set forth in claim 1, wherein a main-material constituting said transparent porous layer is cellulose nitrate, acetyl cellulose, cellulose acetate, vinyl chloride, polypropylene, polyamide, polytetrafluorethylene, polyolefin, polysulfone, glass fiber, or alumina, and a main material constituting said colored porous layer is cellulose nitrate, acetyl cellulose, cellulose acetate, vinyl chloride, polypropylene, polyamide, polytetrafluorethylene, polyolefin, polysulfone, glass fiber, or alumina.

32. The display device as set forth in claim 2, wherein a main material constituting said transparent porous layer is cellulose nitrate, acetyl cellulose, cellulose acetate, vinyl chloride, polypropylene, polyamide, polytetrafluorethylene, polyolefin, polysulfone, glass fiber, or alumina, and a main material constituting said colored porous layer is cellulose nitrate, acetyl cellulose, cellulose acetate, vinyl chloride, polypropylene,. polyamide, polytetrafluorethylene, polyolefin, polysulfone, glass fiber, or alumina.

33. The display device as set forth in claim 3, wherein a main material constituting said transparent porous layer is cellulose nitrate, acetyl cellulose, cellulose acetate, vinyl chloride, polypropylene, polyamide, polytetrafluorethylene, polyolefin, polysulfone, glass fiber, or alumina, and a main material constituting said colored porous layer is cellulose nitrate, acetyl cellulose, cellulose acetate, vinyl chloride, polypropylene, polyamide, polytetrafluorethylene, polyolefin, polysulfone, glass fiber, or alumina.

34. The display device as set forth in claim 1, wherein said transparent porous layer is formed from a mixture of any two or more of resin, ceramic, and glass materials, and said colored porous layer is formed from a mixture of any two or more of resin, ceramic, and glass materials.

35. The display device as set forth in claim 2, wherein said transparent porous layer is formed from a mixture of any two or more of resin, ceramic, and glass materials, and said colored porous layer is formed from a mixture of any two or more of resin, ceramic, and glass materials.

36. The display device as set forth in claim 3, wherein said transparent porous layer is formed from a mixture of any two or more of resin, ceramic, and glass materials, and said colored porous layer is formed from a mixture of any two or more of resin, ceramic, and glass materials.
